(19) United States
(12) Patent Application Publication
(10) Pub. No.: US 2017/0357676 A1
(43) Pub. Date: Dec. 14, 2017

(54) INDEX WEIGHT CALCULATOR

(71) Applicant: HEWLETT PACKARD ENTERPRISE DEVELOPMENT LP, Houston, TX (US)

(72) Inventors: Cipriano A. Santos, Palo Alto, CA (US); Ivan Adrian Lopez Sanchez, Guadalajara (MX); Fernando Orozco Sanchez, Tlaquepaque (MX); David Farrington Ludwig, Austin, TX (US); Etienne Canaud, Shanghai (CN)

(21) Appl. No.: 15/543,358

(22) PCT Filed: Jan. 22, 2015
(86) PCT No.: PCT/US2015/012371

§ 371 Date: Jul. 13, 2017

(51) Int. Cl. G06F 17/30; G06Q 10/04; G06F 17/18; G06F 17/16

(52) U.S. Cl. CPC G06F 17/30336; G06F 17/16; G06Q 10/04; G06F 17/18; G06F 17/30616

(57) ABSTRACT

In one example, a device to calculate a relative set of weighted indices for a set of objectives includes an input device that receives a prioritized list of the set of objectives. A user interface module creates a square matrix of the set of objectives and their subjective relative intensity of importance includes a module to query for subjective intensity of importance between respective objectives in the prioritized list of objectives. The user interface module only presents as options select subjective intensity of importance which preserve a transitivity property of the prioritized list of objectives. A compute module calculates a principle eigenvector of the square matrix to thereby create the relative set of weighted indices.

### BACKGROUND

There are many scenarios and projects in which various indices or objectives need to be met or reviewed to determine if they have been optimized. Often times it is helpful to know how much a particular index or objective contributes to the outcome of a project in order to determine how various costs or benefits are to be distributed or whether predetermined goals have been achieved. However, while many people can subjectively rank various indices or objectives, they have great difficulty in expressing quantitatively the relative differences between the indices or objectives. If their guessed quantitative values are inaccurate, improper selection of projects, distributions of costs, or allocation of benefits could lead to serious consequences. For the purposes of this application, objectives and indices are effectively synonymous and are used appropriately to aid in clarity and understanding.

### BRIEF DESCRIPTION OF THE DRAWINGS

The claimed subject matter is better understood with reference to the following drawings. The elements of the drawings are not necessarily to scale relative to each other. Rather, emphasis has instead been placed upon dearly illustrating the claimed subject matter. Furthermore, like reference numerals designate corresponding similar parts through the several views.

FIG. 1 is an example index weight calculator device;

FIG. 2A is an example user interface screen to get a prioritized list of decision maker objectives;

FIG. 2B is another example user interface to get decision maker's subjective relative importance between the different objectives;

FIG. 3 is an example block diagram of a computing system implementing an index weight calculator;

FIG. 4 is an example flow chart of the process used to create weighted indices based on the decision maker's prioritized list of objectives;

FIG. 5 is an example table of relative intensity of importance options and their descriptions;

FIG. 6A is an example matrix upper triangle illustrating the various options available for relative intensity of importance given the example choices made;

FIG. 6B is an example flowchart of how to fill in the upper triangle using a decision maker's subjective input while maintaining transitivity of the original decision maker's prioritized list;

FIG. 7 is an example summary flow chart of the overall method to create weighted indices while maintaining transitivity; and

FIG. 8 is an example chart illustrating the use of the created weighted indices to achieve various results.

### DETAILED DESCRIPTION

The inventors have created a user friendly index weight calculator (IWC) tool or device that helps decision makers (or other users) to define weights for various objectives or indices that reflect the overall relative prioritized importance (or ranking from most important to least important) of the objectives. These defined weights can be used in various manners to help the decision maker manage their enterprises, such as for selection and scheduling of a portfolio of projects in such a way that the trade-offs of the multiple conflicting objectives can be optimized while considering budget, labor, and business constraints.

The inventors' tool allows a decision maker to make a subjective overall ranking and relative importance within a set of objectives and compute an objective set of weighted indices. For instance, a decision maker person (or persons) creates an overall subjective prioritized ordered list (or ranking) of the objectives and then that person further provides a set of additional relative subjective “intensity of importance” selections using ordinary text and/or percentages between each set of the various objectives. However, the person is only offered by the IWC tool for selection those “intensity of importance” values that maintain the beginning overall subjective order (transitivity property) of the prioritized list.

Thus, while that person may be unable to quantitatively express their relative weighting for each objective, by helping guide them through a subjective based process which ensures their original transitivity of objectives is preserved, the index weight calculator tool can process the overall and various relative subjective analyses made by the person to create a quantitative result of weighted indices. If desired, IWC tool may allow the person to fine-tune the weighted index results or start the process in the index weight calculator over until they feel confident in the final weighted index results. The IWC tool ensures consistency with the original prioritized ordered list of objectives by only allowing evaluations during pairwise comparisons of objective that guarantee the transitivity property (that is, the original overall relative ranking of the objectives is preserved). Thus, the index weight calculator ensures that a person's various subject judgments are not inconsistent with each other.

Transitivity is a key property of both partial order relations and equivalence relations. Transitivity occurs whenever one element is related to a second element and the second element is related to a third element, then the first element is also related to the third element. Examples of transitive relations are “less than” for real numbers (a<b and b<c implies a<c) and divisibility for integers (a divides b and b divides c mean that a divides c). Similarly for a set of objectives being evaluated, if a first objective has a higher priority than a second objective and the second objective has a higher priority than a third objective, the first objective has a higher priority than the third objective.

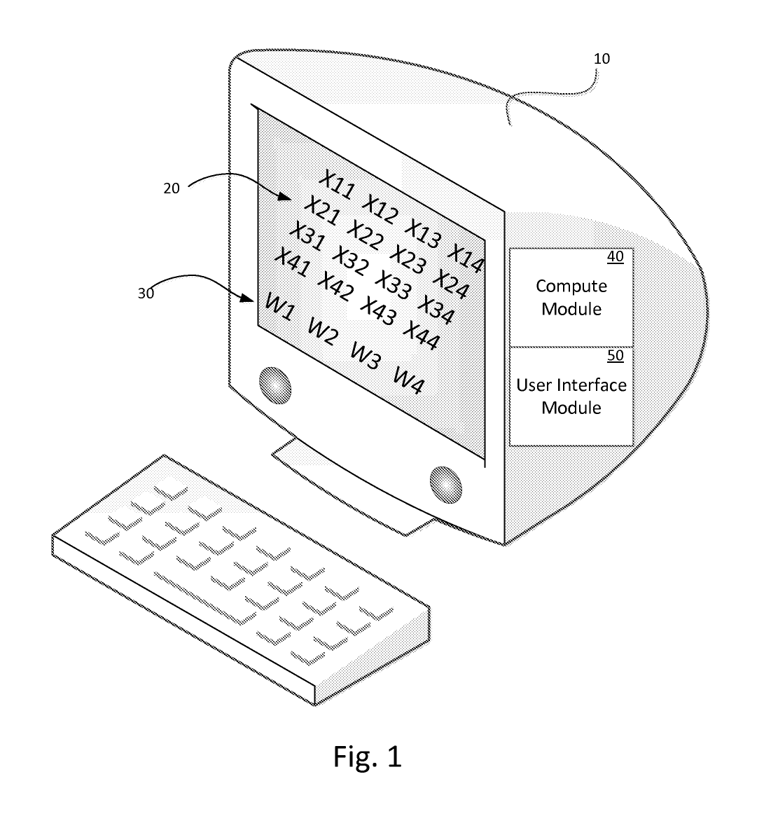

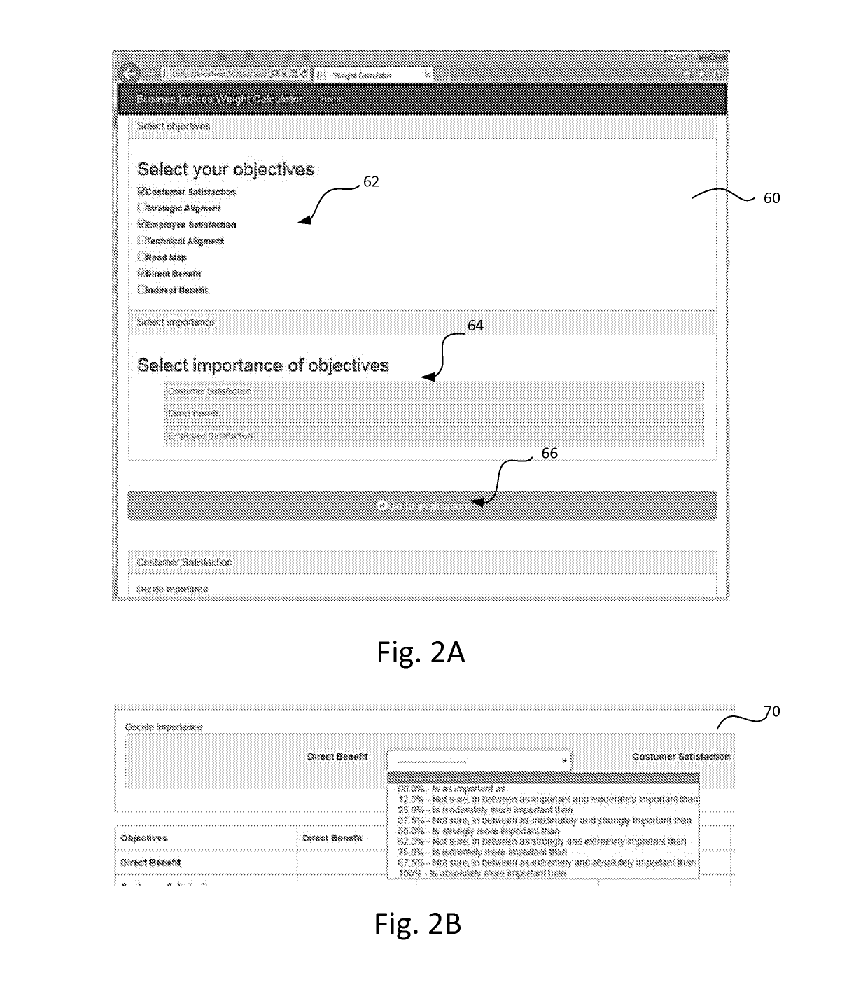

FIG. 1 is an example index weight calculator device 10 implementing the IWC tool that includes a compute module 40 and a user interface module 50. The user interface module 50 provides a decision maker a set of user interfaces to enter a prioritized list of a set of objectives (see 60, FIG. 2A) and a set of subjective relative intensity of importance (see 70, FIG. 2B). These subjective inputs are used by the compute module 40 to create a square matrix 20 (which may or may not be displayed). The compute module 40 then processes the square matrix 20 to create a final set of weighted indices 30.

FIG. 2A is an example user interface screen 60 to get decision maker objectives and their overall relative importance. For instance, the decision maker can be presented with a predetermined list 62 of objectives or the decision maker could choose to enter new objectives which are not presented in other examples. In this example, the decision maker has selected “Customer Satisfaction” (highest priority), “Direct Benefit”, and “Employee Satisfaction”, respectively, as the chosen ordered objectives to evaluate.

After the decision maker has selected the particular set of objectives from the predetermined list 62, then in drag and drop section 64, the decision maker in this example can rearrange the order of the selected objectives with the highest priority on top and descending in priority to the bottom of the list. This creates the original transitivity property of the chosen set of objectives. When the prioritized list is completed, the decision maker may then proceed to the next step in FIG. 2B.

FIG. 2B is another example user interface 70 to get the decision maker's subjective relative importance between the chosen objectives. In this example, the decision maker is asked to select the intensity of importance between “Direct Benefit” and “Customer Satisfaction.” In this example, 9 options are shown as this is the first comparison on the ordered list. As various relative comparison are presented, the options available for the intensity of importance will lessen depending on the earlier choices made by the decision maker. The intensity of importance may be a text based description, a relative percent description, a ranking description, or any combination. Here, both a percentage and text description are presented. More detail on how the variable intensity of importance choices are determined follow a more detailed description of index weight calculator device 10 system.

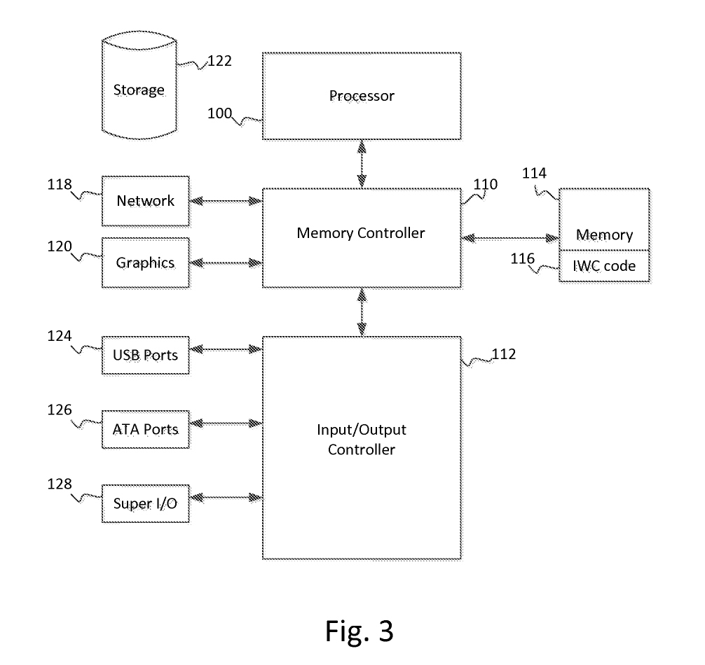

FIG. 3 is an example block diagram of a computing system implementing an index weight calculator (IWC) device 10 with compute module 40 and user interface module 50. Processor 100 is connected to memory controller 110 which is further connected to Input/Output (I/O) controller 112. Memory controller 110 provides a high bandwidth and high speed interface to network 118, graphics 120, and non-transient computer readable memory 114 which includes instructions for performing tasks on processor 100, such as Index Weight Calculator (IWC) code 116.

I/O controller 112 provides several different input/output interfaces to allow processor 100 to retrieve or provide information. Several types of I/O channels are shown as non-limiting examples, such as Universal Serial Bus (USB) Ports 124, Asynchronous Transfer Attachment (ATA) Ports 126, and Super I/O 128 which provides conventional serial, parallel, and PS/2 interfaces. While memory controller 110 and I/O controller 112 are shown as two separate blocks, in some examples the blocks may be combined or alternatively broken into several different blocks. Further, many of the various attached I/O and memory may be integrated onto either the memory controller or I/O controller to provide more integral solutions. Processor 100 may also be combined with the various blocks to create system on a chip (SOC) implementation examples. Storage 122 may be connected to IWC device 10 in various possible fashions, such as with Network 118, ATA Ports 126, and USB ports 124. Storage 122 may include one or more copies of various objective lists, IWC code 116, and index weight based application programs.

The IWC code 116 and application programs may also be described in the general context of non-transitory computer code or machine-useable instructions, including computer-executable instructions such as program modules or logic, being executed by a computer or other machine, such as a personal data assistant or other handheld device. Generally, program modules including routines, programs, objects, components, data structures, etc., refer to code that performs particular tasks or implements particular abstract data types. The IWC code 116 and application programs may be practiced in a variety of system configurations, including handheld devices, consumer electronics, general-purpose computers, more specialty computing devices, etc. They may also be practiced in distributed computing environments where tasks are performed by remote-processing devices that are linked through a communications network.

With reference to FIG. 3, IWC device 10 includes one or more communication channels or busses that directly or indirectly couples the following devices: memory 114, one or more processors 100, one or more graphics 120 connected to various forms of displays, input/output (IO) devices 112 (and accordingly USB Ports 124, ATA ports 126, and Super I/O 128), and one or more network or other communication devices 118. Various combinations of the blocks shown may be integrated into common blocks. Accordingly, such is the nature of the art, and FIG. 3 is merely illustrative of an exemplary computing device that can be used in connection with one or more embodiments of the present IWC device 10. Distinction is not made between such categories as “workstation,” “server,” “laptop,” “handheld device.” etc., as all are contemplated within the scope of FIG. 3 and reference to a “computing device.” IWC device 10 typically includes a variety of computer-readable media.

Computer-readable media can be any available non-transitory media that can be accessed by IWC device 10 and includes both volatile and nonvolatile media, removable and non-removable media. By way of example, and not limitation, computer-readable media may comprise computer storage media 122 and communication media. Computer storage media 122 include both volatile and nonvolatile, removable and non-removable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information and which can be accessed by IWC device 10. Communication media typically embody transitory computer-readable instructions, data structures, program modules, or other data in a modulated data signal such as a carrier wave or other transport mechanism and include any information delivery media. However, once received, stored, and used, the communication media becomes non-transitory. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above should also be included within the scope of computer-readable media.

Memory 114 includes computer-storage media in the form of volatile and/or nonvolatile memory, such as IWC code 116. The memory may be removable, non-removable, or a combination thereof. Exemplary hardware devices include solid-state memory, hard drives, optical-disc drives, etc. IWC device 10 includes one or more processors 100 that read data from various entities such as memory 114 or 1/O controller 112. Graphics(s) 120 present data indications to a user or other device. Example display components include a display device, speaker, printing component, vibrating component, etc.

I/O controller 112 allow IWC device 10 to be logically coupled to other devices, some of which may be built in. Illustrative components include a keyboard, a mouse, a trackpad, a microphone, joystick, game pad, satellite dish, scanner, printer, wireless device, etc.

Network 118 allows IWC device 10 to communicate with other computing devices including a datacenter servers through one or more intranet, Internet, private, custom, or other communication channels whether wireless, wired, optical, or other electromagnetic technique.

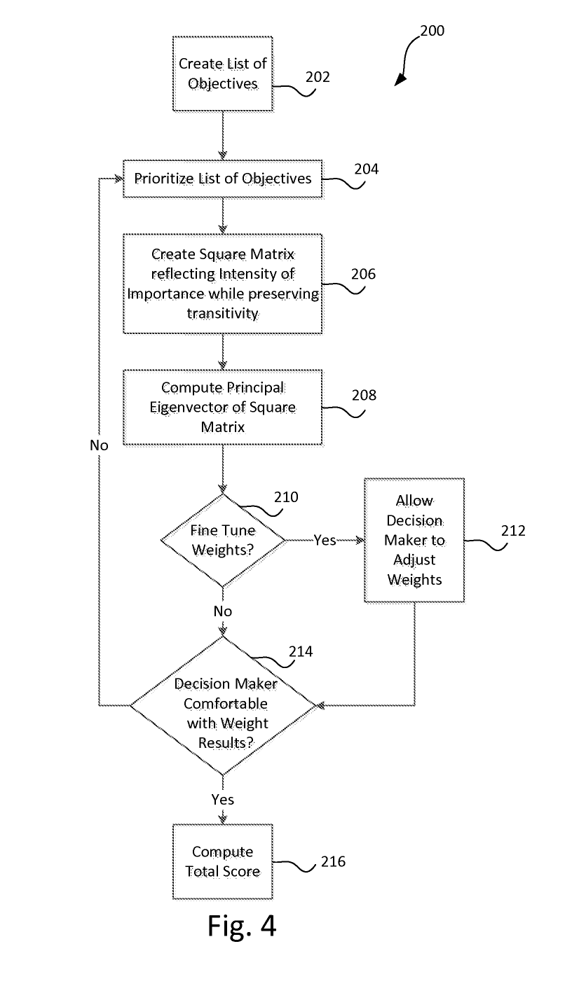

FIG. 4 is an example flow chart of the IWC process 200 used to create weighted indices based on the decision maker's prioritized list of objectives. In block 202, a list of objectives is created. This can be done by hand entry, by loading a file (such as a spreadsheet or word processing document), or by loading a list from one or more historical databases, as just a few examples. In block 204, the list of objectives is prioritized subjectively by a decision maker to establish a transitivity property for the list. This is accomplished in one example by ordering the list in ascending order where the lowest number is the highest priority. In other examples, the list may be ordered in descending order with the highest number having the highest priority. The ordering can be done in a drag-and-drop method, or it can be ordered by placing a respective order number before or after the respective objectives.

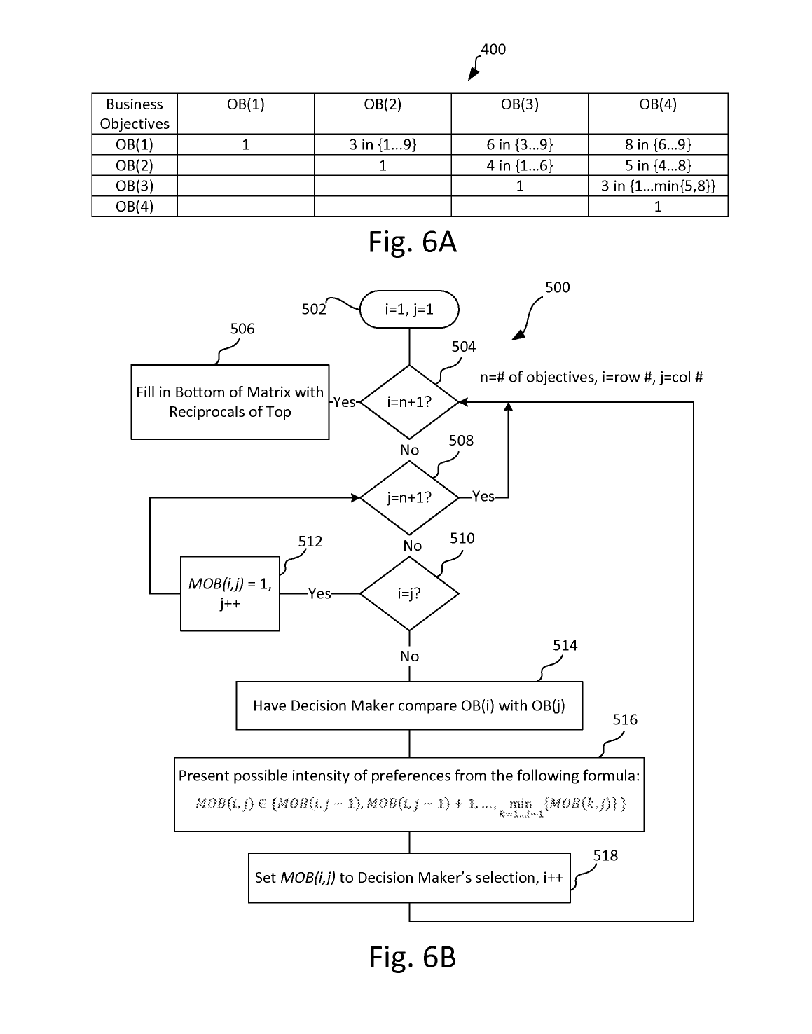

Once the prioritized list of objectives is complete, the IWC process 200 in block 206 creates a Square Matrix that reflects the subjective intensity of importance while preserving the original transitivity property of the prioritized list of objectives. More detail of this block 206 is described in FIGS. 6A-6B below. In block 208, the principal eigenvector of the Square Matrix is computed to create a set of weighted indices that objectively reflect the subjective decisions made by the decision maker with respect to the original prioritized list of objectives and the relative Intensity of Importance selections between respective objectives. There are several known ways to compute the principal eigenvector of a square matrix. For the Python computer language, one option is the NumPy library to compute the principal eigenvector accessed at http//www.scipy.org/scipylib/download.html.

The set of weighted indices 30 are presented to the decision maker and if the decision maker believes they do not accurately reflect (in block 210) what the decision maker believes is an accurate weighting of the objectives, the decision maker may fine tune the weights (perhaps to just round the numbers) in block 212. Alternatively, if the decision maker does not wish to fine tune the results but would rather retry the process with different selections for the Intensity of Importance options, or is otherwise uncomfortable with the weighted index results in block 214, then the decision maker may restart the process by beginning again at block 204. If the decision maker is comfortable with the weighted index results in block 214, then the weighted index results can be applied to the set of objectives to compute a total score in block 216.

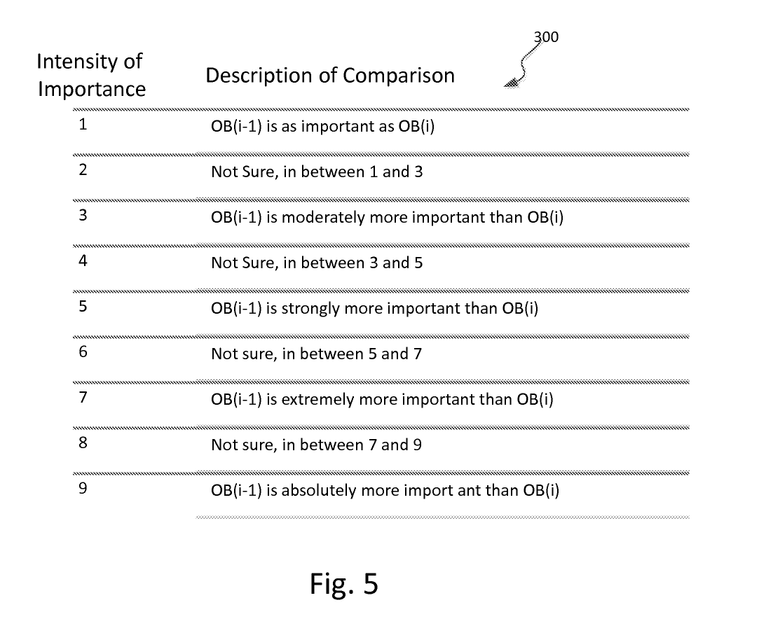

FIG. 5 is an example table of the relative intensity of importance options or possibilities and their descriptions when comparing two objectives OB(i−1) and OB(i) for i=2 . . . n. However, the terms OB(i−1) and OB(i) should be replaced with the actual objective names being compared, OB(i) having an equal or lower priority than OB(i−1).

Note that in the FIG. 2B example, the intensity of importance values in the set {1, 2, 3 . . . 8, 9} in FIG. 5 are replaced by a percentage reflecting how OB(i−1) is more important than OB(i). The set of percentage values are {0.0%, 12.5%, 25.0% . . . 87.5%, 100.0%} as shown in FIG. 2B. These percentage values do not have any unit of measure and are easier for many decision makers to grasp when comparing objectives OB(i−1) and OB(i). For example, when the decision maker is indifferent (each objective is as important as the other) between OB(i−1) and OB(i), the 0.0% value can be interpreted as: objective OB(i−1) has zero intensity of importance with respect to objective OB(i). At the other extreme, the 100.0% value can be interpreted as: the decision maker is absolutely in favor of Objective OB(i−1) when compared with Objective OB(i). Starting from indifference, at an intensity of importance value of 0.0%, the intensity of importance value for each gradient is increased by ⅛=0.125 (12.5%) until reaching a value of 100.0%. However, for the following example, the actual set of numbers (1, 2 . . . , 8, 9) from FIG. 5 is used in the MOB matrix instead of the percentage values used in the example GUI of FIG. 2B.

To keep consistency with the ranking of objectives established by the decision maker, the IWC device 10 should only display comparison values that are consistent with the original ranking of the objectives. For example, if the decision maker defined the intensity of importance of objective OB(1) with respect to objective OB(2) as 5, then when comparing OB(1) with OB(3) the intensity of importance of OB(1) with respect to OB(3) cannot be 1, 2, 3, or 4. This is because OB(2) was indicated as more important than OB(3). Therefore, when using OB(1) as the unit of comparison it cannot be that the intensity of importance of OB(1) respect to OB(3) is less than the intensity of importance respect to OB(2), otherwise this would make OB(3) more important than OB(2) when compared in terms of OB(1) contradicting the initial ranking of objectives.

Consequently, the possible values of the cells in the first row of the MOB matrix are:
MOB(1,2)ε{1,2 . . . 8,9}, MOB(1,3)ε{MOB(1,2), MOB(1,2)+1, . . . , 9}, . . . MOB(1,n)ε{MOB(1,n−1),MOB(1,n−1)+1, . . . , 9}.
   Similarly, to keep consistency when at a cell MOB(i,j) for 1<i<j, since objective MOB(k) is more important than objective MOB(i) for k=1, 2 . . . i−1, then the intensity value MOB(i,j) cannot be larger than min_{k=1 . . . i-1}(MOB(k,j)) because it would make objective OB(i) more important than some objective OB(k) for k=1 . . . i−1, thereby withdrawing the transitive property of the original ranking. Also, since OB(j−1) is equal or more important than OB(j) then the intensity value MOB(i,j) cannot be smaller than MOB(i,j−1) for 1<i<j. Therefore, OB(i,j)ε{OB(i,j−1), OB(i,j−1)+1, . . . , min_{k=1 . . . i-1}{OB(k,j)}}.

FIG. 6A is an example matrix upper triangle 400 illustrating example choices and the various options available for relative intensity of importance (i.e. choice shown was taken from available set in (1 . . . 9)). In this example, consider 4 objectives with the following initial ranking of OB(1)>OB(2)>OB(3)>OB(4). The square matrix of Objectives (MOB) is selected by a decision maker as shown in FIG. 6A along with the available options and here in table 1 with just the chosen values shown that preserve the transitivity property of the initial ranking:

TABLE 1
Example Subjective Evaluation of Objectives
where rows are i, columns are j

| Objectives | OB(1) | OB(2) | OB(3) | OB(4) |
|---|---|---|---|---|
| OB(1) | 1 | 3 | 6 | 8 |
| OB(2) | | 1 | 4 | 5 |
| OB(3) | | | 1 | 3 |
| OB(4) | | | | 1 |

For example, in the first row, MOB(1,2) the chosen value is 3 but could have been any value between 1 and 9. Similarly, since 3 was chosen in MOB(1,2), then MOB(1,3) has an optional choice set of 3 to 9 and in this example 6 is chosen. Form MOB (1,4), since 6 was chosen for MOB(1,3) then its set of choices are 6 to 9. Note that when comparing an objective OB(i) with OB(j) where i=j, it would be indifferent with itself and thus the only choice is 1 and can be filled in automatically. In the second row, MOB(2,3) has choices from 1 to 6 because MOB(2,2) is 1 and MOB(1,3) is 6. In this example 4 is chosen for MOB(2,3). This would then make the available choices for MOB(2,4) to be between 4 and 8 due to the values in MOB(2,3) and MOB(1,4), respectively. For MOB(2,4) 5 is chosen. This choice then restricts the choices available for MOB(3,4) to be 1 and the minimum of the values in the rows above which are 5 and 8. The minimum being 5 means the actual choices for MOB(3,4) is 1 to 5 of which 3 was chosen.

FIG. 6B is an example flowchart 500 of how to fill in the upper triangle, diagonal, and then lower triangle for a square matrix of n number of objectives using a decision maker's subjective input while maintaining transitivity of the original decision maker's prioritized list. For this illustration, let n=4. The upper left cell of MOB is used to begin the process by setting i=1 and j=1 in block 502. Then if i is not equal to n+1 (5) in block 504 and j is not equal to n+1 (5) in block 508 then i is compared to j in block 510 and if equal MOB(i,j) is set to 1 (for the diagonal as shown in FIG. 6A) and j incremented to move to the next column. If i is not equal to j then in block 514, the decision maker is asked to compare OB(i) with OB(j). The decision maker is presented with a list of possible intensity of preference in block 516 with values for the MOB(i,j) cell from the formula:

$$MOB ( i , j ) ∈ \{ MOB ( i , j - 1 ) , MOB ( i , j - 1 ) + 1 , … , {min}_{k = 1 … i - 1} \{ MOB ( k , j ) \} \}$$

Then in block 518, MOB(i,j) is set to the decision maker's selection and i is incremented to move to the next row and control returned to block 504. Each cell in MOB is filled out column by column, row by row until there are no more rows determined by block 504 when i is greater than n. If so, then in block 506, the bottom of the square matrix MOB is filled in with respective reciprocals (e.g. MOB(i,j)=1/MOB(j,i)) of the top matrix.

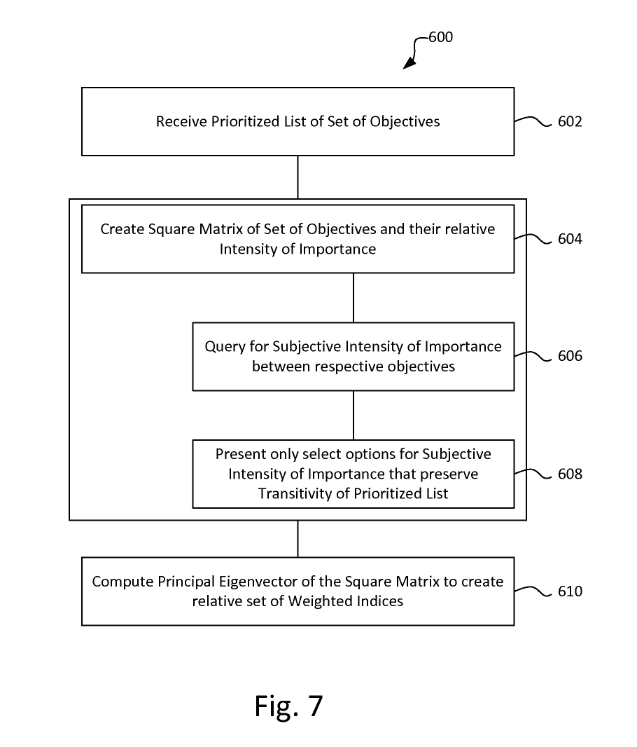

FIG. 7 is an example flow chart 600 that summarily describes the overall method to create weighted indices while maintaining transitivity. In block 602 a prioritized list of a set of objectives is received. In block 604, a square matrix of the set of objectives and their relative intensity of importance is created. This is done such as for example in block 606 where a decision maker is queried for the subjective intensity of importance between respective objectives and in block 608 where only those select options for the subjective intensity of importance that preserve transitivity of the prioritized list of objective are presented for query in block 606. After the square matrix of block 604 has been created, then in block 610, the principal eigenvector of the square matrix is computed to create a quantifiable relative set of weighted indices.

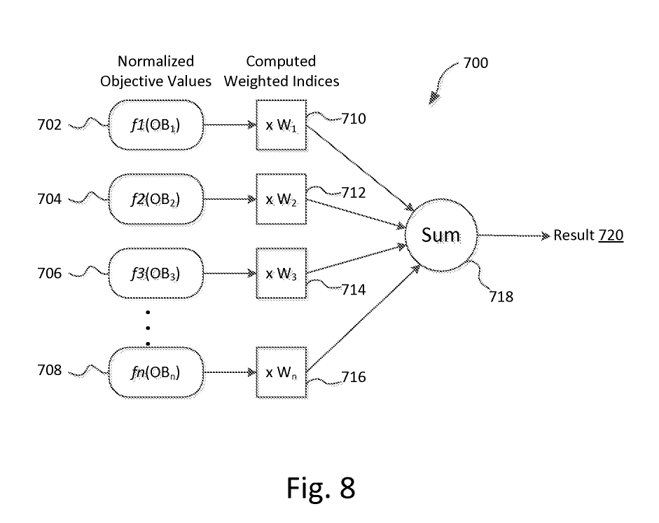

FIG. 8 is an example chart 700 illustrating the use of the created weighted indices to achieve various results. Each of the objectives OB1 . . . OBn is normalized. There are several different ways to normalize values and thus for each objective there may be a respective normalization function (fn). For instance, say one objective is timeliness of meeting a project's completion deadlines. If the deadlines were met in 20 of 25 instances, that could be normalized to 80%, If customer quality were another objective, survey results could be taken and returned and say an average score of 4.5 out of 6 were received, then a normalized score could be 4.5/6 or 75%. Accordingly, each of OB1 to OBn is normalized by the appropriate function in blocks 702, 704, 706, and 708. The normalized objective values are then multiplied by the respective objective weighted indices that were computed by the IWC device 10 in respective blocks 710, 712, 714 and 716. The weighted normalized objective values are then summed in block 718 to arrive at a result 720. Some particular application examples follow below.

### Application to Project Portfolio Optimization

Project Portfolio Optimization entails selecting and scheduling a set of project opportunities that optimizes various Business Objectives while primarily satisfying labor and budgets constraints. One important Business Objective to consider during Project Portfolio Optimization is the total Project Score maximization. The Project Score is the aggregation of multiple Business Objectives of interest and can be defined as the weighted average of the project score respect to each of the Business Objectives under consideration.

Let θεO be the index of a Business Objective in the set of Business Objectives, π(p, θ) be the score of project p respect to Business Objective θ, and w(θ) is the weight of Business Objective θ reflecting the relative importance of the Business Objective.

Therefore, the project score, S(p), is formally defined as follows

$$S ( p ) = {\sum }_{θ ∈ O} w ( θ ) * π ( p , θ )$$

Assume that the project score with respect to each Business Objective is known, π(p, θ) (it can be estimated using historical data and determining the impact that similar projects have on Business Objective θ). Then, the remaining question is how to determine the weights w(•) reflecting the relative importance of the Business Objectives under consideration. The IWC device 10 can be used for this purpose.

Assume that four example Business Objectives are to be considered during Project Portfolio Optimization. The four example Business Objectives in order of importance are
1. Direct Benefit (DB)
2. Customer Satisfaction (CS)
3. Technical Alignment (TA)
4. Indirect Benefit (IB)

The IWC device 10 can be used to compute the weights for the four Business Objectives. For example, the decision maker may believe that DB is strongly more important than CS, not sure that DB is extremely more important or absolutely more important than IB, and TA is strongly more important than IB; etc.

The IWC device 10, uses the data in the MOB matrix, computes the weights of the four Business Objectives under consideration. Assume that the following outcome occurred:
1. Direct Benefit (DB) has a weight of 64.18%
2. Customer Satisfaction (CS) has a weight of 20.33%
3. Technical Alignment (TA) has a weight of 11.20%
4. Indirect Benefit (IB) has a weight of 4.29%

The decision maker might manually fine tune the computed weights as follows:
1. Direct Benefit (DB) has a weight of 60.00%
2. Customer Satisfaction (CS) has a weight of 20.00%
3. Technical Alignment (TA) has a weight of 10.00%
4. Indirect Benefit (IB) has a weight of 10.00% (Note that the summation of the computed weights must be equal to 100.00%)

An alternative to fine tuning the weights is for the decision maker to go back to the Business Objectives comparisons and revise the intensity of preferences. Suppose that the decision maker thinks that DB and CS are both very important, much more important than TA and IB. Assume that the new weights are as follows:
1. Direct Benefit (DB) has a weight of 44.09%
2. Customer Satisfaction (CS) has a weight of 40.38%
3. Technical Alignment (TA) has a weight of 8.28%
4. Indirect Benefit (IB) has a weight of 7.45%

Suppose the decision maker then fine tunes the weights as follows
1. Direct Benefit (DB) has a weight of 42.00%
2. Customer Satisfaction (CS) has a weight of 42.00%
3. Technical Alignment (TA) has a weight of 9.00%
4. Indirect Benefit (IB) has a weight of 7.00%

Now consider a particular project P1, and assume the following values (scores) of P1 respect to each of the objectives.

| | |
|---|---|
| Score(P1, DB) = $80.35M | maximum possible value $500M |
| Score(P1, CS) = 230 | maximum possible value 237 |
| Score(P1, TA) = 27 | maximum possible value 100 |
| Score(P1, IB) = $123.14M | maximum possible value $1,500M |

The project score is normalized with respect to each of the objectives considering the maximum possible value, in this way the score is a number between 0 and 100, and all the scores are at the same scale. Therefore, the normalized scores (NS) are
NS (P1, DB)=16.07%
NS (P1, CS)=97.05%
NS (P1, TA)=27%
NS (P1, IB)=8.21%

Hence, the Project Score of project P1 is computed as follows

$$S ( P 1 ) = {\sum }_{θ ∈ O} w ( θ ) * π ( p , θ )$$

$$S ( P 1 ) = ( 0.42 ) * ( 16.07 ) + ( 0.42 ) * ( 97.05 ) + ( 0.09 ) * ( 27 ) + ( 0.07 ) * ( 8.21 ) = 50.51$$

### Application to Resource Management Optimization

Resource Management Optimization addresses the problem of optimizing the allocation of fractional employees' capacity to FTE job requirements at each time period of a planning horizon; while optimizing multiple business objectives such as skill score, availability score, and allocation costs, among others.

The multiple business objectives relevant during the allocation of resource capacity to satisfy FTE job requirements can be aggregated into a metric called Matching Score. The Matching Score measures how well an employee is suitable to perform a job. There are several dimensions to describe the suitability of an employee to perform a job. For example, skill score, availability score, and allocation costs. The Matching Score of resource e when allocated to satisfy job requirements of job j can be calculated as follows

$${MS}_{e , j} = {\sum }_{θ ∈ Θ} {σ}_{θ} ( e , j ) * {W}^{θ}$$

Where θεΘ is the index of a score type in the set of score types, σ_{θ}(e,j)ε[0,100] is the score type value of resource e respect to job j (score type values are normalized in the direction of maximization, and W^{θ} is the relative weight of the score type). The IWC device 10 can be used to determine the weights W^{θ} similarly as described in the previous example application.

Accordingly, while a decision maker may be unable to quantitatively express their relative weighting for each objective, the IWC device 10 helps guide them through an automated subjective based process that ensure their original ranking or transitivity of objectives is preserved while providing a final set of objective weights which can be used in several types of applications, such as project portfolio optimization and resource matching optimization. Accordingly, the IWC device 10 device is able to evaluate a set of subjective evaluation of objectives and turn those into an objective quantitative relationship between the objectives.

While the present claimed subject matter has been particularly shown and described with reference to the foregoing preferred and alternative examples, those skilled in the art will understand that many variations may be made therein without departing from the spirit and scope of the claimed subject matter as defined in the following claims. This description of the claimed subject matter should be understood to include all novel and non-obvious combinations of elements described herein, and claims may be presented in this or a later application to any novel and non-obvious combination of these elements. The foregoing examples are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A method of computing a relative set of weighted indices for a set of objectives, comprising:
receiving a prioritized list of the set of objectives;
creating a square matrix of the set of objectives and their subjective relative intensity of importance including,
querying for subjective intensity of importance between respective objectives in the prioritized list of objectives,
presenting as options select subjective intensity of importance which preserve a transitivity property of the prioritized list of objectives; and
computing a principal eigenvector of the square matrix thereby creating the relative set of weighted indices.

2. The method of claim 1 wherein the square matrix is designated as MOB with i rows and j columns and n objectives, and the presenting as options for an upper triangle of MOB select subjective intensity of importance values include selecting as options for
$$MOB ( i , j ) \vert \frac{i = 1 , 2 , … , n}{j = i + 1 , … n}$$
from the set of:
$$\{ MOB ( i , j - 1 ) , MOB ( i , j - 1 ) + 1 , … , \frac{min}{k = 1 … i - 1} \{ MOB ( k , j ) \}$$

3. The method of claim 2 wherein the select subjective intensity of importance values are translated to human understandable descriptions.

4. The method of claim 2 wherein the step of creating the square matrix further comprising:
filling a diagonal of the square matrix with 1's; and
computing the reciprocal of the selected upper triangle values of the square matrix and filling in corresponding lower triangle values of the square matrix.

5. The method of claim 1 further comprising:
multiplying the respective relative set of weighted indices by corresponding normalized objective scores from the set of objectives; and
summing the results to arrive at a total score.

6. A device to calculate a relative set of weighted indices for a set of objectives, comprising:
an input device to receive a prioritized list of the set of objectives;
a user interface module to create a square matrix of the set of objectives and their subjective relative intensity of importance including a module to query for subjective intensity of importance between respective objectives in the prioritized list of objectives, the user interface module only to present as options select subjective intensity of importance which preserve a transitivity property of the prioritized list of objectives; and
a compute module to calculate a principle eigenvector of the square matrix to thereby create the relative set of weighted indices.

7. The device of claim 6 wherein the square matrix is designated as MOB with i rows and j columns and n objectives, and the query for an upper triangle of MOB select subjective intensity of importance values include the selection as options for
$$MOD ( i , j ) \vert \frac{i = 1 , 2 , … , n}{j = i + 1 , … n}$$
from the set of:
$$\{ MOB ( i , j - 1 ) , MOB ( i , j - 1 ) + 1 , … , {min}_{k = 1 , … i - 1} \{ MOB ( k , j ) \}$$

8. The device of claim 7 wherein the select subjective intensity of importance values are translated to human understandable descriptions.

9. The device of claim 7 wherein the compute module further comprises logic to:
fill a diagonal of the square matrix with 1's; and
compute the reciprocal of upper triangle values of the square matrix and to fill corresponding lower triangle values in the square matrix.

10. The device of claim 6 further comprising an additional compute module to multiply each of a respective objective normalized scores in the list of prioritized objectives by their respective corresponding calculated weighted indices and to sum the results to create a total score.

11. A non-transitory computer readable media, having computer executable instructions for an index weight calculator, comprising modules to:
receive a prioritized list of the set of objectives;
present a user interface to create a square matrix of the set of objectives and their subjective relative intensity of importance including to query for subjective intensity of importance between respective objectives in the prioritized list of objectives, the user interface only to present as options select subjective intensity of importance which preserve a transitivity property of the prioritized list of objectives; and
calculate a principle eigenvector of the square matrix to thereby create a relative set of weighted indices for each objective in the set of objectives.

12. The computer readable medium of claim 11 wherein the square matrix is designated as MOB with i rows and j columns and n objectives, and the query for an upper triangle of MOB select subjective intensity of importance values comprise the selection as options for
$$MOD ( i , j ) \vert \frac{i = 1 , 2 , … , n}{j = i + 1 , … n}$$
from the set of:
$$\{ MOB ( i , j - 1 ) , MOB ( i , j - 1 ) + 1 , … , {min}_{k = 1 , … i - 1} \{ MOB ( k , j ) \}$$

13. The computer readable medium of claim 12 wherein the select subjective intensity of importance values are translated to human understandable descriptions.

14. The computer readable media of claim 12 wherein the module to calculate a principle eigenvector further includes logic to:
fill a diagonal of the square matrix with 1's; and
compute the reciprocal of upper triangle values of the square matrix and to fill corresponding lower triangle values in the square matrix.

15. The computer readable media of claim 11 further comprising a module to multiply each of a respective objective normalized score in the list of prioritized objectives by their respective corresponding calculated weighted indices and to sum the results to create a total score.
